(19) United States
(12) Patent Application Publication
(10) Pub. No.: US 2007/0259626 A1
(43) Pub. Date: Nov. 8, 2007

(54) Transmitter and receiver for wireless high speed data transmission

(76) Inventor: William Albert Hastings, Las Vegas, NV (US)

Correspondence Address: William A. Hastings, III, 848 N. Rainbow Blvd., #471, Las Vegas, NV, 89107, US

(21) Appl. No.: 11/492,512

(22) Filed: Jul. 24, 2006

Related U.S. Application Data
(60) Provisional application No. 60/795,925, filed on Apr. 28, 2006.

(51) Int. Cl. H04B 1/04

(52) U.S. Cl. 455/103; 455/550.1

(57) ABSTRACT

An apparatus and method for wireless high speed data transmission in a communication system are described. In one embodiment, the apparatus comprises multiple radio-frequency (RF) signal generators to generate multiple RF signals and a switch having inputs coupled to receive the RF signals and to receive data from a data source. The switch has an output that outputs one of RF signals based on the data.

### PRIORITY

The present patent application claims priority to and incorporates by reference the corresponding provisional patent application Ser. No. 60/795,925, titled, “Transmitter and Receiver for Wireless High Speed Data Transmission” filed on Apr. 28, 2006.

### FIELD OF THE INVENTION

The field of the invention is wireless communication; more specifically, the present invention is related to generating multiple radio frequency (RF) signals and modulating data by selecting one of the multiple RF signals.

### BACKGROUND OF THE INVENTION

FIG. 1 is a block diagram of prior art RF transmitter. In a typical RF transmitter, an oscillator signal from oscillator 101 and a data signal from data source 103 are fed into a mixer 102. The mixer 102 creates a modulated signal that passes through a power amplifier 104, a band pass filter 105, and an antenna 106, which transmits the signal through the air.

For frequency modulation, the mixer 102 must output two different frequencies depending upon whether the data is a one or a zero. The transition from one frequency to another is slow and limits the data transmission rate. The same is true for amplitude and phase modulation.

### SUMMARY OF THE INVENTION

An apparatus and method for wireless high speed data transmission in a communication system are described. In one embodiment, the apparatus comprises multiple radio-frequency (RF) signal generators to generate multiple RF signals and a switch having inputs coupled to receive the RF signals and to receive data from a data source. The switch has an output that outputs one of RF signals based on the data.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a prior art RF transmitter;

FIG. 2 is a block diagram of one embodiment of a multi-oscillator RF transmitter;

FIG. 3 illustrates an example of a phase modulated signal transmitted by the transmitter;

FIG. 4 illustrates a phase modulated signal at the receiver;

FIG. 5 is a block diagram of one embodiment of a receiver;

FIG. 6 is a schematic for a transmitter to produce the phase modulated signal according to one embodiment of the present invention; and

FIG. 7 is a block diagram of one embodiment of cellular phone.

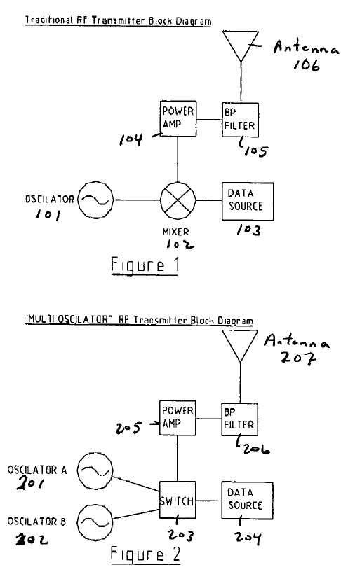

### DETAILED DESCRIPTION OF THE PRESENT INVENTION

A multi-oscillator transmitter and receiver for transferring data in a radio frequency (RF) communication system are described. For purposed herein, RF includes all electromagnetic radiation including, for example, microwave, infrared, etc. Also, for purposes herein, data includes all types of information including, but not limited to, voice information.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

A wireless communication system is disclosed. The communication system includes one or more transmitters and receivers. In one embodiment, a transmitter includes multiple radio-frequency (RF) signal generators to generate multiple different RF signals and a switch that receives the RF signals and data from a data source and has an output that outputs one of the RF signals based on the data.

FIG. 2 is a block diagram of one embodiment of a multi-oscillator RF transmitter. In the multi-oscillator transmitter, there are two oscillators, oscillator 201 and 202, with two different frequencies (for frequency modulation, two different amplitudes for amplitude modulation or two different phases for phase modulation). When data comes into the switch 203 from data source 204, the output is switched from one oscillator to another.

In one embodiment, switch 203 may be a series of discrete transistors (e.g., npn transistors) with impendence loads (e.g., 50 ohm).

The output of switch 203 then goes through the same circuitry as a traditional transmitter for transmission through the air. In one embodiment, that circuitry includes power amplifier 205, bandpass fitter 206 and antenna 207. Note that power amplifier 205 and bandpass filter 206 are not required. In one embodiment, switch 203 and power amplifier 205 are part of the same integrated circuit. In another embodiment, bandpass filter 206 is also part of that integrated circuit.

The advantage of the multi-oscillator transmitter is the switch 203 can transition from one frequency to another at a much faster rate than the traditional oscillator/mixer can. Therefore, it enables a faster data transmission rate.

Note that although FIG. 2 shows two oscillators for two different frequencies, the present invention is not limited to two. It could be multiple oscillators with different frequencies, phases, amplitudes or a combination of each.

The term oscillator in this context is defined as a means of generating an RF signal. Oscillators 201 and 202 can be a crystal oscillator, a voltage control oscillator, or any other means of creating an RF signal. The ideal RF signal is a perfect sign wave.

In one embodiment, oscillator 201 and oscillator 202 can be two separate devices or circuits generating two different frequencies. In an alternate embodiment, oscillators 201 and 202 are separate devices or circuits generating the same frequency but different amplitudes or phases. In still another embodiment, oscillators 201 and 202 are two separate devices or circuits generating a combination of the above.

Alternatively, oscillator 201 can generate the primary signal and oscillator 202 may simply be circuitry that modifies the primary signal, e.g., increases or decreases amplitude, frequency, phase or a combination of those.

The transmitter of FIG. 2 enables high speed data transmission rates which current receivers cannot keep up with. Hence, a faster receiver is needed.

The digital phase receiver is a receiver for receiving high data rate phase modulation transmissions.

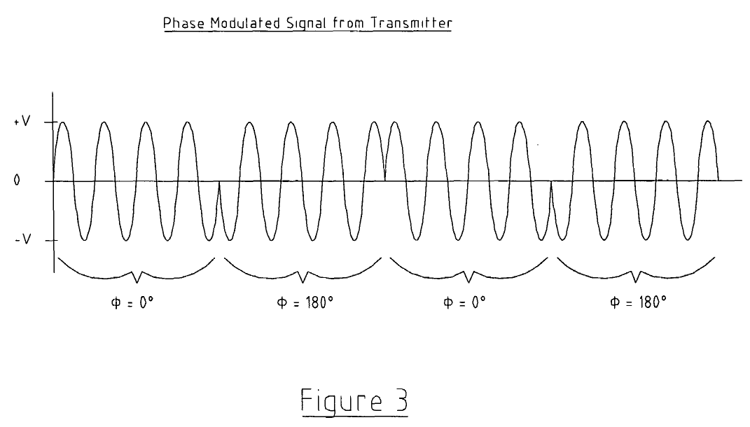

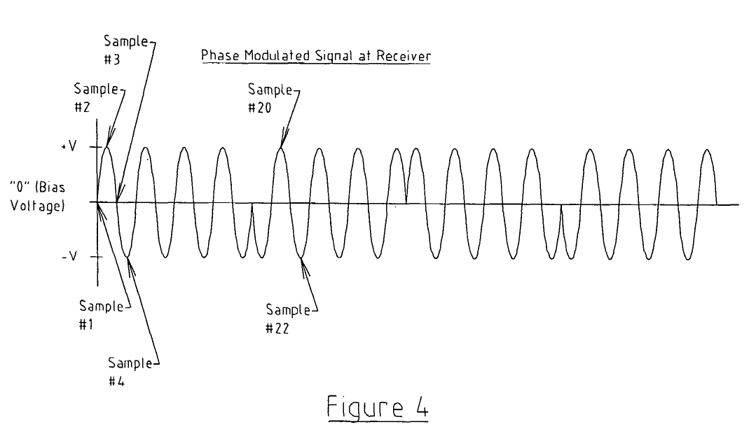

FIG. 3 is an example of a phase modulated signal transmitted by the transmitter of FIG. 2. Starting at the left side of FIG. 3 are 4 complete sine waves with a phase of 0 degrees, i.e., Φ=0°. Following that, there are another 4 complete sine waves with a phase of 180 degrees, i.e., Φ=180°.

Note that it is an arbitrary decision as to which is a digital “1”, 0° or 180°. But once that decision is made, it must be consistent for both the transmitter and receiver. For the following discussion, at is assessed that a “digital 0” as Φ=0° and a “digital 1” is Φ=180°. With this convention, the signal shown in FIG. 3 is 0101.

The sine waves in FIG. 3 are the RF carrier waves. In other words, if the transmission frequency is 820 MHz (a frequency appropriate for modern cell phones), the transmitter transmits a wireless signal through the air which has a frequency of 820 MHz. For purposes herein, “carrier wave cycle” is defined as being one full sine wave.

The data is modulated into that carrier wave. In FIG. 3, one “data cycle” is 4 carrier wave cycles. This means that data is modulated into carrier wave every 4 carrier wave cycles. In FIG. 3, if the carrier wave frequency is 820 MHz, the data transmission rate is 205 Mbps (mega bits per second). Note that the present invention is not limited to this carrier wave frequency, nor this data transmission rate.

In one embodiment, the number of carrier wave cycles per data cycle is a parameter that is selected by the system engineer. Theoretically, only one (or less) carrier wave cycle is required for a data cycle. In one embodiment, the number of carrier waves required is a function of the speed of the switch, the strength of the signal at the receiver and noise.

The system engineer may design the data processor to have a variable carrier wave cycle to data cycle ratio. This may enable the data processor to adjust the ratio based on signal strength and noise at the receiver. The new ratio must be communicated to both the receiver and transmitter. A reliable communication system or mechanism is selected for this communication under the existing condition.

The lower the carrier wave cycle to data cycle ratio, the faster the data transmission rate. A 4:1 is a reasonable ratio under good conditions.

When the signal is received by the receiver, voltage measurements are made at a rate of every ¼ of a carrier wave period (or 90 degrees). FIG. 4 illustrates a phase modulated signal at the receiver. Referring to FIG. 4, the odd numbered samplings are to measure the “bias voltage” of the incoming signal. The bias voltage is defined as the center of the sign wave and can be thought of as “0” volts relative to the sign wave. In a real world receiver with real world noise, the bias voltage will rarely be 0 volts relative to the receiver's ground.

By comparing the even number voltage readings to the preceding odd number readings, a determination is made as to whether the bit is a 1 or a 0. Take Sample 20 as an example. Since the voltage is +V, it is known that the signal phase is 180° and thus the data is a one. Sample 22 being a −V confirms that the bit is a 1.

In a 4 carrier wave cycle per data cycle embodiment, there are 8 bias voltage readings and 8 data voltage readings. This provides redundancy to compensate for the noise of a real world system. In one embodiment, a data processor in the receiver takes an average of the readings for a data cycle to determine whether the bit is a 1 or a 0. Depending on how the system is designed, the data processor may require all 8 data voltage readings to be in agreement or it may only require a subset of all possible data voltage readings to be in agreement (e.g., 5). As mentioned above, even more redundancy may be required.

Note that the present invention is not limited to 4 samples per sine wave as shown in FIG. 4. Any number of samples may be used.

### An Example of a Receiver

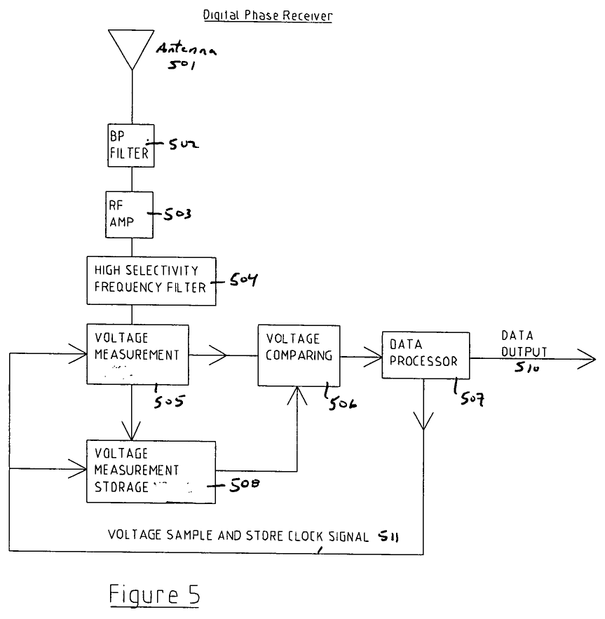

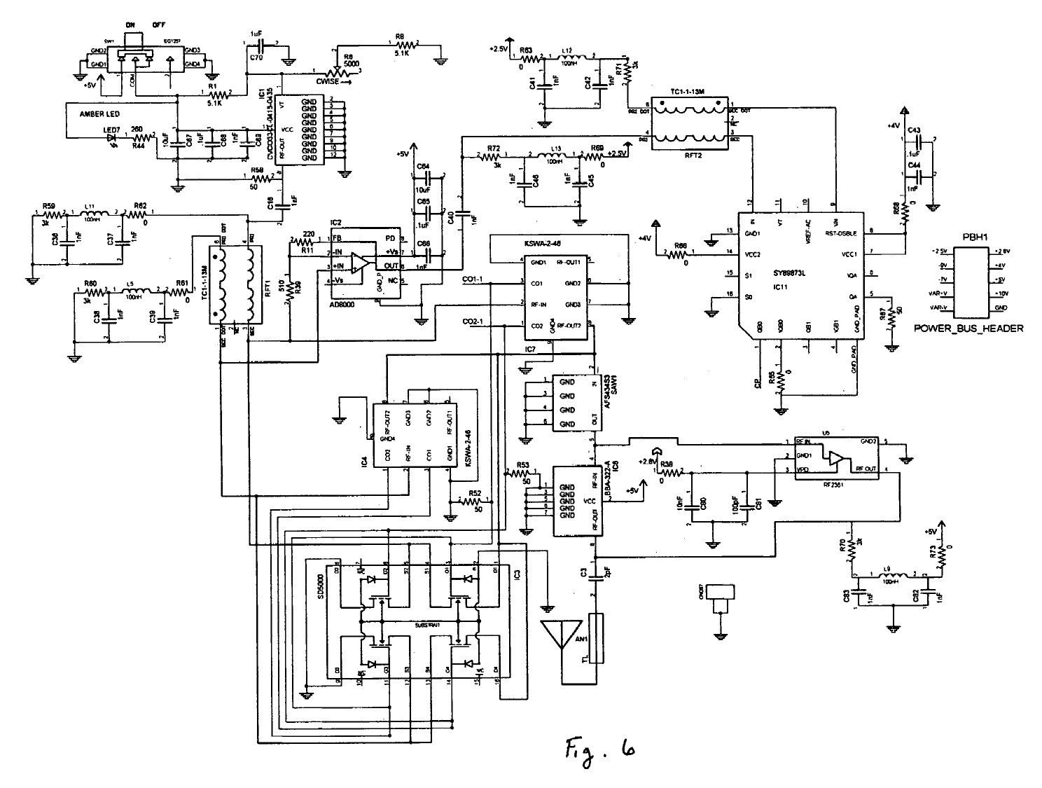

FIG. 5 is a block diagram of one embodiment of a receiver. Referring to FIG. 5, antenna 501 receives the phase modulated signal. The signal passes through using bandpass filter 502 and is then amplified using amplifier 503. A high selectivity frequency filter 504 then filters the signal. Once the signal has been filtered, a voltage measurement mechanism 505 measures the voltages and stores them in voltage measurement storage 508. The voltage measurement mechanism 505 may be a microcontroller that includes an A/D converter that produces a digital output indicative of the voltage level. In another embodiment, the voltage measurement mechanism 505 includes a correlator and match filter, or a microcontroller having an analog input.

Both voltage measurement and storage are performed in response to signal 511 from data processor 507. The voltage measurements are compared using a voltage comparator 506 and the results of the comparison are sent to data processor 507, which generates data output 510 in response thereto.

To determine the numerical value of each bit in the received phase modulated signal, the receiver initially takes samples of the signal at intervals along each sine wave (e.g., the odd samples). From some of those samples, the voltage bias level (i.e., the center of the sine wave) is determined, as well as the specific time the sine wave is at the voltage bias level. After determining these characteristics of the voltage bias level, the voltage level of certain samples (e.g., the even samples) is compared to the voltage bias level. Using the results of the comparisons along with the time of each sample relative to the samples used to set the voltage bias level, the numerical value of the data is determined.

More specifically, in one embodiment, voltage measurement mechanism 505 measures voltages of samples of the phase modulated signal taken at predetermined intervals for each data cycle. Voltage comparator 506, which is coupled to voltage measurement mechanism 505, compares measured voltages output from the voltage measurement unit for each data cycle. Using the results of the comparisons, data processor 507 determines bits to be output in response to the phase modulated signal. As set forth above, data processor 507 determines bits to be output by determining a voltage bias level and a first set of samples corresponding to the voltage bias level (e.g., the odd samples) and evaluates results of the comparisons of the voltage levels of a second set of samples (e.g., the even samples) to the voltage bias level and the time the second set of samples were taken relative to samples of the first set of samples to determine a numerical value associated with each data cycle.

In one embodiment, the receiver includes a control unit 520 to facilitate power management functions within the receiver. Control unit 520 is coupled to RF amplifier 503 to place the RF amplifier in a reduced power consumption state (e.g., a powered down state) at transition times in the phase modulated signal when transitioning between each data bit. Turning off the power to the power amplifier during the transition time is beneficial because any noise that is created due to switching is ignored and, thus, does not cause problems when generating data at the receiver. In another embodiment, control unit 520 is coupled to one or more of voltage measurement mechanism 505, voltage comparator 506 and data processor 507 to prevent processing of samples of the phase modulated signal at transition times in the phase modulated signal when transitioning between each data bit. Control unit 520 may prevent voltage measurement mechanism 505, voltage comparator 506 and data processor 507 from processing samples by placing one or more of them in a reduced power consumption state (e.g., a powered down state) at transition times in the phase modulated signal when transitioning between each data bit.

### A Transmitter Schematic

FIG. 6 is a schematic for a transmitter to produce the phase modulated signal according to one embodiment of the present invention. The operation of the circuit is as follows.

Starting in the upper left corner of the schematic, a mechanical on-off power switch is used to provide +5 volts dc power to the voltage control oscillator (VCO), IC1. In another embodiment, the power switch is electronically controlled. The amber LED, LED7, is a visual indicator that the VCO has power.

The VCO produces an RF signal at the desired transmission frequency when the correct tuning voltage is input to pin 1. The tuning voltage is controlled via the 5000 ohm potentiometer, R6. In another embodiment, the tuning voltage is controlled electronically. In one embodiment, the transmission frequency for this circuit is designed is 434 MHz. This frequency is within a frequency band approved by the United States FCC for operation by licensed HAM operators. In another embodiment, the frequency is in the 800 MHz and the 1900 MHz ranges, which are approved by the FCC for mobile (cell) phone operation.

The VCO produces a phase of 0 degrees, i.e., Φ=0°, and can be thought of as oscillator 201. The transformer, RFT1, produces a phase of 180 degrees, i.e., Φ=180°, and can be thought of as oscillator 202.

For switching between the 2 phases, a switch (switch 203) is required. This circuit has the option of installing one of two different switches, the KSWA-2-46 or the SD5000, on the printed circuit board. This option allows testing of the performance of the switches.

The switches switch from a phase of 0 to a phase of 180 depending on the data that is to be modulated. The data is input to line CO1-1 and CO2-1 as differential input. (Differential input means that if CO1-1 is high, CO2-1 is low, and vice versa.)

During the switching process, undesirable frequencies are produced. In one embodiment, the SAW filter, SAW1, is used as a narrow band pass filter.

To increase the strength of the signal transmitted, an RF amplifier is used. This circuit has the option of installing one of two different RF Amplifiers, the BBa-322-A, IC6, or the RF2361, U5, on the printed circuit board. This option allows testing of the performance of the amplifiers. If the RF2361 is used, a 12 nH inductor is installed in series above the 3 k ohm resistor, R70. This inductor is not shown on the schematic.

After the amplifier, the signal to be transmitted goes to the antenna and is transmitted wirelessly through air (or whatever the medium is) to the receiver. The receiver circuitry is not shown.

For the transformer, RFT 1, it is shown that the outputs also lead to an operational amplifier, IC2, AD8000. This device, along with the RF Transformer, RFT2, and the frequency divider, IC11, SY89873L, form a circuit that provides a timing signal for the data generator. The transmitter circuit performs better, i.e., better data transmission rates, if the timing of the data input is synchronized with the RF signal coming from the oscillator. As shown in this circuit, the timing signal is a frequency divider and divides by 4 that is an output timing signal of 108 MHz. In other embodiments, a timing circuit that may be used includes a divide by 2, 8, 16, 32, etc. In yet another embodiment, the timing circuits are frequency multipliers that perform multiplication by 2, 4, 8, etc. Multiplying by 8 would produce an output timing signal of 2.47 GHz.

### An Example Cellular Phone

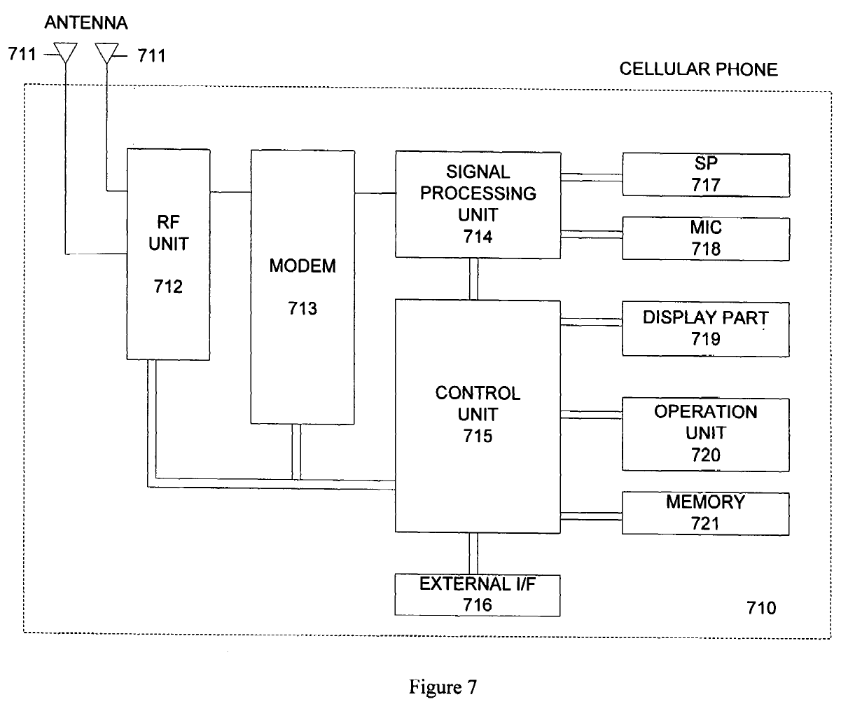

FIG. 7 is a block diagram of one embodiment of a cellular phone that may include the transmitter and/or the receiver described above. Referring to FIG. 7, the cellular phone 710 includes an antenna 711, a radio-frequency transceiver (an RF unit) 712, a modem 713, a signal processing unit 714, a control unit 715, an external interface unit (external I/F) 716, a speaker (SP) 717, a microphone (MIC) 718, a display unit 719, an operation unit 70 and a memory 721.

In one embodiment, the external terminal 716 includes an external interface (external I/F), a CPU (Central Processing Unit), a display unit, a keyboard, a memory, a hard disk and a CD-ROM drive.

The CPU in cooperation with the memories of cellular phone 710 (e.g., memory 721, memory, and hard disk of the external I/F 716) cooperate to perform the operations described above.

Note that the transmitter and/or receiver may be included in a base station or other wireless devices (e.g., a wireless LAN).

The external I/F can be connected to a notebook, laptop, desktop or other computer. This can enable the cell phone to act as a wireless modem for the computer. The cell phone can be the computer's connection to the internet, WiFi and WiMAX, a local area network, a wide area network, a personal area network, Bluetooth.

FIG. 6 Parts List

| | Manufacturer's | | Supplier's | |
|---|---|---|---|---|
| Description | Part Number | Manufacturer | Part Number | Supplier |
| Amplifier, Op, | AD8000YRDZ | Analog | | Analog |
| | | Devices | | Devices |
| Amplifier, RF, High Gain, 10–4000 MHz | BBA-322-A | | | Digikey |
| Amplifier, RF, LNA & PA | RF2361 | RF Micro | | RF Micro |
| | | Devices | | Devices |
| Band Pass Filter, SAW, 434 MHz | AFS434S3 | | 535-9246-1-ND | Digikey |
| Caps, misc. values, Ceramic, 04 | | Panasonic | | Digikey |
| Inductor, 12 nH, 04 | 0402CS-12NXL | Coilcraft | | Coilcraft |
| Inductor, 100 nH, 04 | 0402CS-R10XL | Coilcraft | | Coilcraft |
| LED, Amber | | | 516-1423-1-nd | Digikey |
| Pot, 5k Ohm, 11 turn | 3223W-1-502E | | 3223W-1-502ECT-ND | Digikey |
| Resistor, 0 ohm, 04 | MCR01MZPJ000 | | | Digikey |
| Resistor, 50, 1% 04 | 9C04021A50R0FLHF3 | | | Digikey |
| Resistor, 220, 1% | | | | |
| Resistor, 260, 1% 04 | 9C04021A2600FLHF3 | | | Digikey |
| Resistor, 510, 1%, 04 | 9C04021A5100FLHF3 | | | Digikey |
| Resistor, 3k, 1% | | | | |
| Resistor, 5.1k, 1%, 04 | 9C04021A5101FLHF3 | | | Digikey |
| Switch, RF, High Speed | KSWA-2-46 | Mini-Circuits | | Mini-Circuits |
| Switch, DMOS FET Array | SD5000 | Universal | | Universal |
| | | Semiconductor | | Semiconductor |
| Transformer, RF, 50 Ohm, 4.5–3000 MHz | TC1-1-13M | Mini-Circuits | | Mini-Circuits |
| VCO, 415–435 MHz | CVCO33CL-0415-0435 | | | Mouser |

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. An apparatus for use in a communication system, the apparatus comprising:
a plurality of radio-frequency (RF) signal generators to generate a plurality of RF signals; and
a switch having a first plurality of inputs coupled to receive the plurality of RF signals and another input coupled to receive data from a data source, the switch having an output that outputs one of the plurality of RF signals based on the data.

2. The apparatus defined in claim 1 wherein the plurality of RF signal generators comprises a plurality of oscillators.

3. The apparatus defined in claim 2 wherein one or more of the plurality of oscillators comprises a voltage controlled oscillator.

4. The apparatus defined in claim 1 wherein the plurality RF signal generators comprise:
a first RF signal generator having an output of a first RF signal that is coupled to a first input of the switch; and
circuitry coupled to receive the first RF signal and generate a second RF signal from the first RF signal, the second RF signal being different than the first RF signal and being coupled to a second input of the switch.

5. The apparatus defined in claim 4 wherein the first RF signal generator comprises an oscillator.

6. The apparatus defined in claim 1 wherein the plurality of RF signals comprises signals having one or more of a group consisting of: different frequencies, different amplitudes, and different phases.

7. The apparatus defined in claim 1 wherein the output of the switch is a phase modulated signal.

8. The apparatus defined in claim 1 wherein the switch comprises a series of transistors with impedance loads.

9. The apparatus defined in claim 1 wherein the switch comprises one or more integrated circuit devices.

10. The apparatus defined in claim 1 further comprising a digital phase receiver to perform digital phase transceiver modulation.

11. The apparatus defined in claim 1 further comprising an antenna coupled to the switch to wirelessly transmit the RF signal output from the switch.

12. The apparatus defined in claim 11 further comprising a power amplifier coupled to the output of the switch and the antenna to amplify the RF signal output from the switch prior to wireless transmission by the antenna.

13. The apparatus defined in claim 12 wherein the switch and the power amplifier are part of a single integrated circuit.

14. The apparatus defined in claim 11 further comprising a bandpass filter coupled to the antenna to filter the RF signal output prior to wireless transmission by the antenna.

15. The apparatus defined in claim 1 wherein the RF signal comprises a microwave signal.

16. The apparatus defined in claim 1 wherein the data comprises voice information.

17. The apparatus defined in claim 1 further comprising an amplitude modulation unit coupled to the output of the switch to perform amplitude modulation on each RF signal being output from the switch to increase in number data bits being transmitted.

18. An apparatus for use in a communication system, the apparatus comprising:
a signal generator to generate a plurality of radio-frequency (RF) signals; and
an output device coupled to the signal generator to output one of one of the plurality of RF signals based on the data from a data source; and
an antenna to wirelessly transmit radio waves corresponding to each one of the plurality of RF signals output from the output device.

19. An apparatus comprising:
a voltage measurement unit coupled to the input to measure voltages of samples of the phase modulated signal taken at predetermined intervals for each data cycle;
a voltage comparator coupled to the voltage measurement unit to compare measured voltages output from the voltage measurement unit for each data cycle; and
a data processor coupled to the voltage comparator to determine bits to be output in response to the phase modulated signal by
determining a voltage bias level and a first set of samples corresponding to the voltage bias level,
evaluating results of comparisons of the voltage levels of a second set of samples to the voltage bias level and the time the second set of samples were taken relative to samples of the first set of samples to determine a numerical value associated with each data cycle.

20. The apparatus defined in claim 19 wherein the voltage comparator compares a first number of odd number voltage samples to an even number of voltage samples, and further wherein the data processor determines bits to be output based on the results of comparing the first number of odd number voltage samples to the even number of voltage samples.

21. The apparatus defined in claim 19 wherein the phase modulated signal is generated by a transmitter comprising:
a plurality of radio-frequency (RF) signal generators to generate a plurality of RF signals; and
a switch having a first plurality of inputs coupled to receive the plurality of RF signals and another input coupled to receive data from a data source, the switch having an output that outputs one of the plurality of RF signals based on the data, wherein the output is the phase modulated signal.

22. The apparatus defined in claim 19 wherein voltages measured by the voltage measurement unit are bias voltages.

23. The apparatus defined in claim 19 wherein the voltage measurement unit comprises one of a group consisting of: a correlator, a match filter, and a microcontroller.

24. The apparatus defined in claim 19 further comprising a memory to store voltages measured by the voltage measurement unit, the voltage comparator coupled to the memory to access stored voltage measurements for comparison.

25. The apparatus defined in claim 19 further comprising:
a transmitter having
a plurality of radio-frequency (RF) signal generators to generate a plurality of RF signals; and
a switch having a first plurality of inputs coupled to receive the plurality of RF signals and another input coupled to receive data from a data source, the switch having an output that outputs one of the plurality of RF signals based on the data.

26. The apparatus defined in claim 19 further comprising an antenna coupled to the voltage measurement unit.

27. The apparatus defined in claim 19 further comprising an RF amplifier coupled to the antenna and the voltage measurement unit to amplify an RF signal received by the antenna.

28. The apparatus defined in claim 27 further comprising a control unit coupled to the RF amplifier to place the RF amplifier in a reduced power consumption state at transition times in the phase modulated signal when transitioning between each data bit.

29. The apparatus defined in claim 22 further comprising a bandpass filter coupled to the RF amplifier and the antenna to filter the RF signal received by the antenna prior to amplification by the RF amplifier.

30. The apparatus defined in claim 23 further comprising a frequency filter coupled to the RF amplifier and the voltage measurement unit to filter the amplified RF signal output from the RF amplifier and provide the filtered, amplified RF signal to the voltage measurement unit.

31. The apparatus defined in claim 19 further comprising a control unit coupled to one or more of the voltage measurement unit, the voltage comparator and the data processor to prevent processing of samples of the phase modulated signal at transition times in the phase modulated signal when transitioning between each data bit.

32. A mobile device comprising:
an antenna;
an RF unit coupled to the antenna, the RF unit having
a multi-oscillator transmitter coupled to the antenna, and
a digital phase receiver coupled to the antenna;
a signal processing unit coupled to the RF unit; and
a control unit coupled to the RF unit and the signal processing unit to control operation of the RF unit and the signal processing unit.

33. An apparatus for use in a communication system, the apparatus comprising:
an oscillator to output an RF signal having a period, the oscillator being responsive to data from a data source to change the RF signal within a fraction of the period, such that the oscillator is capable of generating a plurality of RF signals; and
an antenna coupled to the oscillator to wirelessly transmit radio waves corresponding to each one of the plurality of RF signals output from the oscillator.
